(19) United States
(12) Patent Application Publication
(10) Pub. No.: US 2010/0319236 A1
(43) Pub. Date: Dec. 23, 2010

(54) Apparatus For Grabbing Fish

(75) Inventor: Franklin Leroy Stebbing, Norfolk, NE (US)

Correspondence Address: BANNER & WITCOFF, LTD., TEN SOUTH WACKER DRIVE, SUITE 3000, CHICAGO, IL, 60606, US

(73) Assignee: Rex Enterprises, LLC, Norfolk, NE (US)

(21) Appl. No.: 12/816,979

(22) Filed: Jun. 16, 2010

Related U.S. Application Data
(60) Provisional application No. 61/218,248, filed on Jun. 18, 2009.

(51) Int. Cl. A01K 83/02; A01K 85/00

(52) U.S. Cl. 43/35; 43/36

(57) ABSTRACT

There is disclosed a fish grabbing device that automatically grabs a fish when the fish explores, strikes or attempts to eat the bait. The grabber may include a coiled body having pointed ends that are held together by detents. When the fish explores the grabber and accompanying bait, the fish trips a trigger, which causes the movement of grabber ends such that they expand within the fish's mouth, thereby catching the fish.

### CROSS-REFERENCE TO RELATED APPLICATION

This application claims priority to U.S. Provisional Application Ser. No. 61/218,248, filed Jun. 18, 2009.

### FIELD OF THE INVENTION

The invention relates generally to a fishing device and more specifically to a reactive fishing device that will grab a fish.

### BACKGROUND AND SUMMARY OF THE INVENTION

It is known that fishing devices are passive, meaning that a hook, lure or trap is used to catch the fish. That is, the fish must bite the hook or lure, or a crab must crawl into the trap before it can be caught. The fishing device of the invention, on the other hand, is reactive, meaning that when the fish investigates the bait, the device responds by latching on or grabbing it.

Historically, fishermen have been using hooks to catch fish for many centuries. The use of fishhooks is found worldwide in both recreational and commercial fishing. The advantages of fishhooks are that they are simple, cheap and somewhat effective at attaching to fish.

The disadvantages are that the fishhooks are dangerous for the fishermen to handle while baiting or casting them and when detaching them from the fish. They also often cause extensive and fatal damage to the fish, which becomes a problem if the fish are being thrown back into the water. The object of releasing the fish back to its environment is so that the fish will grow and repopulate but often the fish die because of the damage done while catching them.

The fish often swallow the bait, making removal very difficult and causing even greater damage to the fish. The fishhooks also often fail to attach to the fish, even when the fish steals the bait.

If the fishhooks become embedded in the skin of a fisherman, they can be very difficult to get out. The known fishhooks often incorporate a barb that is meant to keep the point buried in the flesh. A recommended way to remove it from human skin is to push the point through the flesh until it exits, then cut the barb off with wire cutters. Then, the hook can be removed by pulling it back out through the entrance wound. This procedure is complicated and often painful.

To overcome these problems, and others, the device of the present invention has been developed. The invention is described below and illustrated in the figures. The device of the invention may take on many forms and embodiments, including the exemplary embodiments described herein. The device of the invention is designed to grip, grab or automatically attach to a fish that is being hunted.

There are numerous objectives of the invention. Some of the objectives of the invention include simplifying the art of catching fish. Making fishing easier for the unskilled and others, such as children, the elderly and the infirm. Allowing the use of several fishing lines simultaneously. Allowing the use of unattended fishing lines. Improving the likelihood of fish capture, especially for the uninitiated. Reducing hook injury to fishermen. Reducing hook injury to the fish. Allowing “capture and release” to be more acceptable because of the much easier removal of the lure from the fish's mouth, thereby increasing the chances of survival after release, thus preserving fish population. Making the placing of bait on the lure easier and less repulsive. Eliminating sharp pointed fishhooks. Eliminating fishhook barbs and attendant safety issues. Greatly reducing accidental hooking of fishermen and bystanders. Eliminating injury to pets and other animals that have unknowingly been attracted to baited fish hooks. Automatically attaching to fish instead of requiring the fishing rod to be jerked when a fish is nibbling on the bait in order to “set” the hook.

As described in more detail below, the invention includes the use of a spring loaded trap to grab the fish instead of traditional fishhooks. In one exemplary embodiment, the trap is designed to open and expand inside of the fish's mouth when the fish tries to feed on it. In another exemplary embodiment, the trap is designed to grab the fish's lip or jaw when the fish trips a trigger. In yet another exemplary embodiment, the trap uses a spring-loaded spear to impale the fish when it trips a trigger.

There are still numerous other variations of the invention including a grabbing device that opens inside of the fish's mouth and can expand and contract as the fish opens and closes its mouth, making it very difficult to dislodge while at the same time minimizing damage to the fish. In another variation, the grabbing device may be hidden in a conventional lure that opens like an umbrella and expands more as the fish tries to pull away from it.

There are many advantages of the invention. Some of these advantages include eliminating the traditional fishhook problems relating to safety issues with sharp barbed points. Reducing injury by replacing sharp points with dull ones, in most cases. Eliminating the need for anti-removal barbs in most cases. Making removal and detachment from fish much easier, safer and faster. Eliminating damage to fish caused by sharp penetrating hooks and embedded barbs. Greatly increasing survival of fish after being caught and released. Eliminating the aforementioned unpleasant aspects of fishing. Improving chances of catching fish because the trap of the invention is automatic and does not require a quick jerking of line when the fish strikes. Reducing the skill required to fish because fish are caught automatically. Encouraging continued participation in fishing by youngsters and uninitiated because of successful catching. Eliminating open visible hooks from the lure making it easier to disguise the lure to make a lure look more realistic—the trap may be completely hidden in the lure. Making handling of lures easier because of the absence of traditional hooks.

With the invention, various configurations are possible depending on the type of fish and method of fishing involved. Some configurations allow the grab to increase tension or expansion as the fish fights to escape. There is versatility of use with different types of lures such as live baits (worms, minnows, leeches, etc), artificial flies, spinners or spoons, and many others in common use. The invention allows much simpler attachment of live bait to the device of the invention when compared to traditional fishhook attachment. For example, a worm can be clamped or pinned by the invention instead of being impaled and then threaded onto the hook—a messy and unpleasant job.

The invention can also be used for catching other marine animals such as crabs and turtles. The invention also provides opportunity for increasing food supplies by increasing fishing harvests. Commercial fishing success using commercial equipment can be improved by using the present invention.

### BRIEF DESCRIPTION OF THE DRAWINGS

FIG. 1 illustrates a side view of a fish grabber attached to a fish shaped lure.

FIG. 2 illustrates the grabber in the expanded position after it has been triggered by the fish.

FIGS. 3a and 3b illustrate the grabber without the lure.

FIGS. 4a and 4b illustrate a close-up view of the detents that hold the device in the loaded position.

FIGS. 5a and 5b illustrate an alternative embodiment of the grabber in a closed and an expanded position that may be designed to work without extension handles for releasing the device from the caught fish.

FIGS. 6a and 6b illustrate the forces involved in the latch and prongs.

FIG. 7 is an exploded view of the latch of FIGS. 5a and 5b.

FIGS. 8a, 8b and 8c illustrate an alternative grabbing device having an alternative action. The device may be embedded in a lure.

FIGS. 9a and 9b illustrate an embodiment of the invention that may be used to catch crabs, lobsters and similar animals.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE EMBODIMENTS

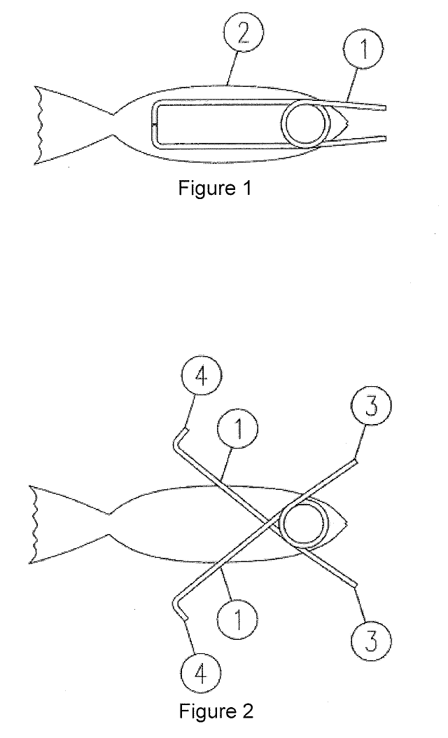

The invention is generally depicted in many alternative embodiments in FIGS. 1-9, but may be embodied in various other forms. The principles and teachings of the invention, therefore, can be applied to numerous alternative variations. Referring to FIG. 1, there is depicted a side view of a fish grabber or trap I attached to a fish shaped lure 2, or may be attached to any other suitable fish-attracting lure. In this view, the grabber 1 is shown in the loaded state, ready to expand when triggered by a fish. This particular lure is soft-bodied so that the biting fish is able to trigger the grabber 1 when its bite compresses the lure. For clarity, the grabber is located on the side of the lure rather than inside, which is one of many alternative locations.

Referring to FIG. 2 there is depicted the grabber 1 in the expanded position after it has been triggered by the fish. The grabber 1 may include a coiled spring body 5. The grabber may also include extension handles 3 that extend outwardly from the coiled spring 5. The grabber may further include pointed ends 4 that also extend outwardly from the coiled spring 5. The pointed ends may extend in a direction opposite of the extension handles 3. The extension handles 3 of the grabber may be located at the front of the lure 2 and are used to retract the pointed ends 4 of the grabber so the device can be removed from the fish's mouth. The fishing line (not shown) may be attached to one of the extension handles 3.

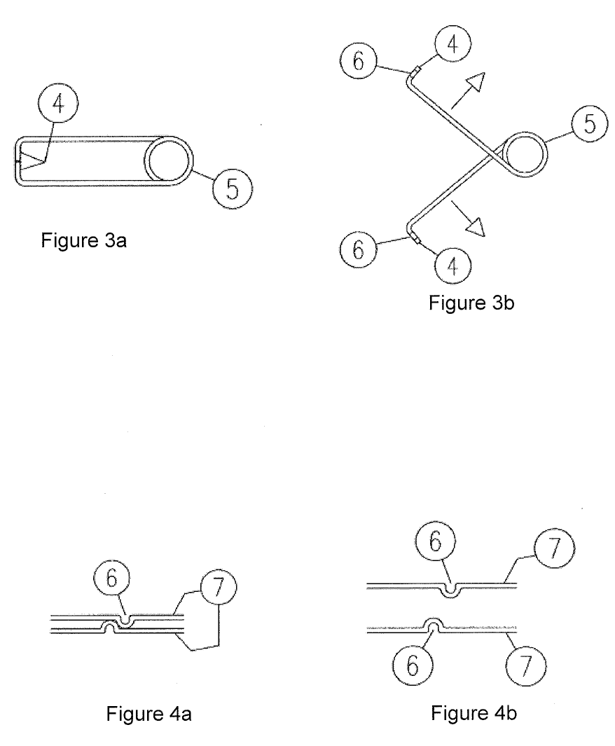

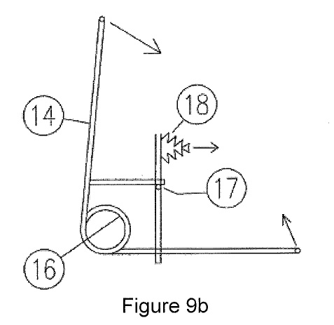

Referring to FIGS. 3a and 3b, there is depicted the grabber of FIGS. 1 and 2 without the lure. The grabber I may define the coiled spring body 5 that drives the pointed ends 4 in opposite directions (as indicated by the direction arrows) when they are released. In this embodiment, the grabber 1 may include detents 6 to hold the device in the loaded condition until it is bitten by the fish. The fish's bite exerts enough force on the detents 6 to drive them past each other thus releasing the points 4 inside of the fish's mouth. The coiled spring 5 exerts forces on the points to drive them open, but the spring may also be arranged to exert a sidewise force so the detents can hold the points 4 in the loaded position until overcome by the fish's bite. In addition to the detents, other suitable triggering mechanisms, such as those of FIG. 9, can be used to initiate the grabbing action when the grabber is disturbed by the fish.

Referring to FIGS. 4a and 4b, there is depicted an exploded view of the detents 6 that hold the device in the loaded position. The aforementioned sidewise force 7 holds these detents against each other until released. The detents 6 are shown on the prongs as an example. They can also be located on the handles 3 or at other convenient locations. It should be understood that the detents 6 can be any formed portion of the handles or pointed ends that permit the handles or pointed ends to remain engaged with each other, respectively, and yet can be disengaged when the grabber is disturbed.

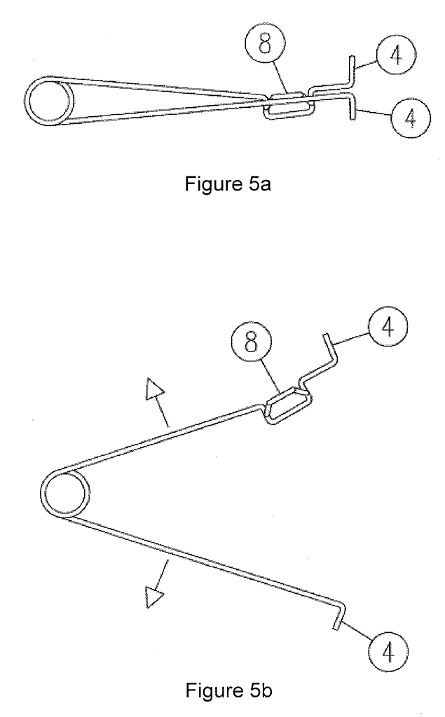

Referring to FIG. 5, there is depicted an alternative grabber, similar to the previous grabber, but this grabber is designed to work without extension handles for releasing the device from the caught fish. It also has a slightly different action. When the fish bites this version, the force of the bite allows the pointed prongs 4 to escape from the latch mechanism 8 so that the prongs can expand in the fish's mouth, capturing it. In this embodiment, the prongs are spring loaded to open but also have a spring loading that forces the prongs to separate somewhat from each other when the latch 8 is released. A slight force from the fish is enough to trigger the device so it can open.

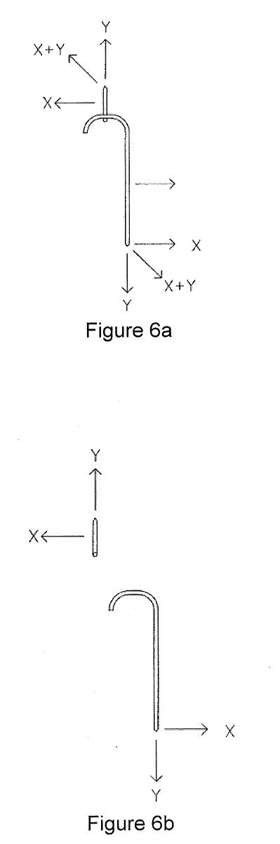

FIGS. 6a and 6b illustrate the forces involved in the latch and prongs. Forces in the +/−“Y” direction are forcing the prongs to open. Sidewise forces in the +/−“X” direction cause the prongs to clear the latch as soon as the prongs are sufficiently disturbed by the bite. Forces “X+Y” result in the prong positions shown in FIG. 6B.

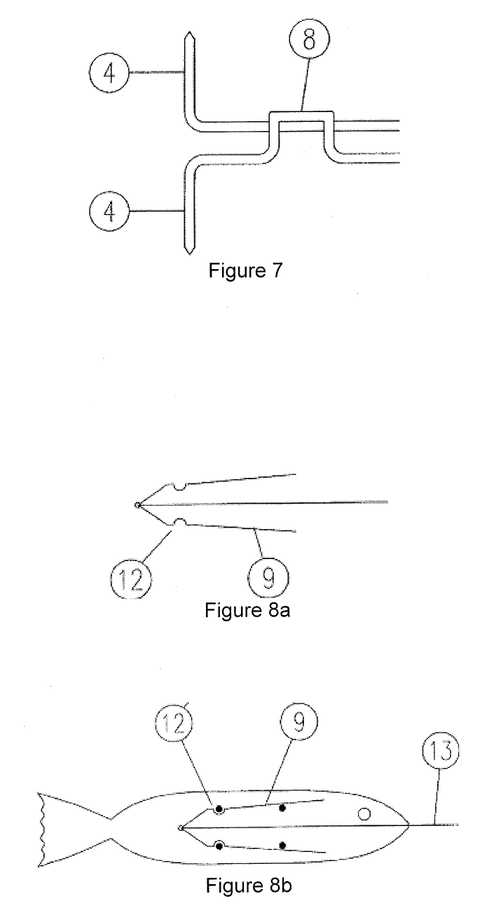

Referring to FIG. 7, there is depicted an exploded view of the latch 8 from FIGS. 5a and 5b.

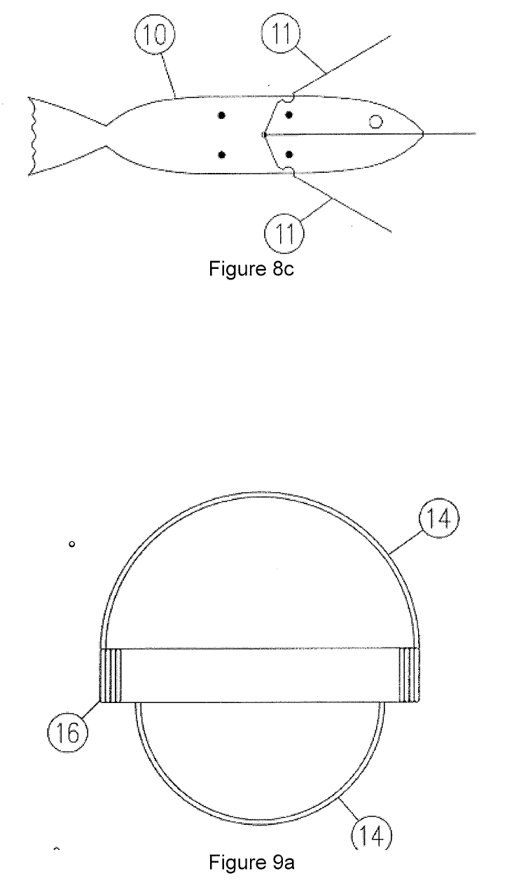

Referring to FIGS. 8a, 8b and 8c, there is depicted an alternative grabbing device 9 with a different action. As shown in FIGS. 8b and 8c, this grabber may be enclosed in a lure 10. This embodiment is designed with articulating prongs 11 that expand somewhat like the ribs of an opening umbrella after the fish strikes. With this embodiment, detents 12 may be used to keep it in the closed position. When the fish strikes, enough force is applied to the line 13 so that the grabbing device is pulled off of the detents 12. Once this occurs, the prongs 11 expand outwardly like an umbrella to catch the fish, as shown in FIG. 8c. A plunger (not shown) may be used between the attached line 13 and the grabbing device 9. When the fish is retrieved, the plunger is used to collapse the prongs to the retracted position so the device can be removed from the fish.

Referring to FIGS. 9a and 9b, there is depicted an alternative device that may be used to catch crabs, lobsters and similar animals. The device has two opposing bars 14. The bars are spring loaded 16. A trigger mechanism 17 is used to hold the bars in the loaded position. The trigger is baited 18. When the animal disturbs the bait 18, the trigger releases the opposing bars, moving the bars 14 as indicated by the direction arrows in FIG. 9b, and the device grabs or captures the animal by its claws and/or mouth parts. The bars 14 may be padded to reduce damage to the animal when capturing it. In an alternative embodiment, a larger version of the device of FIGS. 9a and 9b may use larger bars 14 that are configured to grasp the body of the creature.

With the embodiments of the invention, additional known fishing components may be used, including 1) conventional fishing equipment such as a hand line or rod and reel along with the grabber device to replace the traditional fishhooks; or 2) commercial fishing systems such as trotlines, droplines, longlines or similar equipment, but with grabbers replacing the conventional hooks; and 3) the grabber, gripper, barbed spear, or similar device of the invention that is designed to automatically attach to a fish when the fish attempts to investigate or eat it. As should be apparent from the above, the grabber of the invention is intended to replace traditional, conventional fishhooks.

The invention is also designed to improve the catch-rate of fish over that of conventional, historic fishhook technology. It does this by automatically grabbing the fish when the fish explores, strikes or attempts to eat the bait. In conventional fishhook use, the fish is required to bite the hook in such a way that the forces of the nibbling or biting action are transmitted up the line to a pole that is being held by the fisherman. The fisherman is then required to sense the vibrations and quickly jerk the rod in an attempt to cause the hook to embed into the fish's mouth. Often the hook is jerked out of the fish's mouth before the pointed end finds a vulnerable spot. At times, the fish quickly spits out the bait when it feels the hook.

Using this invention, the fish is “grabbed” instead of being hooked. When the fish explores the grabber, the fish trips a trigger or otherwise causes an automatic reaction from the grabber. The grabber is designed to either grab or expand, or even impale the fish, in some cases.

The grabber of the invention does not require the fish to attach itself, or for the fisherman to cause an action that hooks the fish. The grabber does it automatically. The grabber is enhanced so it is attractive to the fish using live bait or artificial disguises to make it look eatable or interesting, much like that currently employed in conventional fishhook technology.

In the use of this device for commercial fishing, multiple grabbers can be attached to a trotline or similar gang-fishing apparatus. The fish will be grabbed by the devices and held fast until retrieved by the fishermen. The fish are not required to accidentally position the hook into their mouths in a particular way to complete the attachment. The fish are much less likely to free themselves after they are attached to the grabber since the grabber flexes and follows along with the movements as the fish opens and closes its mouth.

As indicated above, in one embodiment, the device is baited by a simple clamping or pinning action—clamping or pinning to the live or artificial bait. A separate clamp or pin, such as a safety pin, can be incorporated just for attaching the bait to the grabber. The invention requires no sharp hooks or other dangerous components. It can be cast without fear of hooking into a bystander. When it is investigated by the fish, the grabber device has a trigger or similar mechanism to initiate a spring-loaded clamping action or grabbing action that instantly grips the fish. In one version, the device expands inside of the fish's mouth and then expands and retracts as the fish opens and closes its mouth. It does not penetrate the fish's flesh to attach, it just applies pressure against the interior of the fish's mouth, flexing as the fish opens and closes its mouth.

This invention makes it much easier to catch fish. It improves the likelihood of fish capture, especially for the uninitiated. The device is baited or otherwise made attractive to the fish and then lowered into the water. No further action is needed. The grabber is checked occasionally and the captured fish are removed. Then the device is reset and returned to the water for more fishing. Removing the fish just requires that the part projecting from the fish's mouth, for example the extension handles, be squeezed or pinched, which retracts the ends of the grabber so it can be readily retrieved. The grabber is very easy to use.

Multiple fishing lines can be used simultaneously. The lines do not need to be attended. This feature is especially valuable to commercial fishermen using trotlines or similar rigs. A capture is almost assured since it is difficult for the fish to steal the bait while escaping the grabber.

When used to catch crabs, the device may use a variation that is triggered by the crab feeding on the bait but is then captured by a spring gripper. It uses a gripping action but one that does not expand in the crabs mouth. The grip grabs one or both claws instead, thus holding the crab until it is retrieved. A larger version employs an arm that extends over the crab's body and holds it fast. It uses a gripping action, it grips the body of the crab, enclosing from its face to the back, somewhat like a hand. This grip can employ padding so the crab shell is not broken.

Some traditional methods for catching crabs use baits that are attached to strings. The baited string is pulled up from the bottom of the water very slowly so as not to disturb the feeding crab. When the crab is near the surface, a dip net is used to catch the crab before it has a chance to react. In a slightly more advanced method, a trot line is used. The trot line is a long cord with bait attached at intervals of several feet. The trot line may be several hundred feet long with floats at either end. A boat is slowly moved along the length of the trot line and the crabs are dipped one by one as they near the surface while the line is retrieved. In a more commercial version, a baited trap with funnel shaped entrance is used. The crabs enter the funnel so they can get at the bait but they are not smart enough to swim back out through the funnel. The advantages for catching crabs over baited strings are: The baits do not need to be constantly checked. The crab will not get fed and leave before he is detected. The crab will be captured as soon as he starts to feed. Many more crabs can be caught using a trot line. The line can be quickly checked without the need for carefully avoiding alarming the crab and loosing it.

For turtles and some other aquatic animals such as otters, the grabber of the invention can grip the head or body or expand in its mouth, depending on the species.

For sharks or other large and dangerous animals, a version of the device can use a spring loaded or gas propelled spear. When the animal triggers the device the spear impales and holds it fast with barbed points. This may kill the fish, making harvesting easier and safer.

As an alternative for these large animals, the device may have the capacity to deliver a lethal electrical jolt to incapacitate or kill the fish after it is captured. The electrical circuit can use battery powered charges to deliver the jolt, much like a stun gun.

In another version, the spring driven spear can be automatically recharged by battery to reload the device if it fails to catch a fish when actuated. This reduces the need to retrieve and reload the device after every discharge.

Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. A fish grabbing device that is attached to a lure comprising:
a coiled spring attached to the lure,
extension handles that extend outwardly from the coiled spring,
pointed ends that extend outwardly from the coiled spring,
a detent on each of the extension handles for holding the handles in a loaded position,
wherein when a fish explores the lure, the fish grabbing device is disturbed causing the detents on the extension handles to move away from each other, thereby releasing the extension handles from a loaded position to an open position, and thereby causing movement of the pointed ends which grab the fish.

2. The fish grabbing device of claim 1, wherein the pointed ends extend outwardly from the coiled spring in a first direction.

3. The fish grabbing device of claim 2, wherein the extension handles extend outwardly from the coiled spring in a second direction.

4. The fish grabbing device of claim 3, wherein the extension handles and pointed ends extend in opposite directions.

5. The fish grabbing device of claim 1, wherein the coiled spring is attached inside the lure.

6. The fish grabbing device of claim 1, wherein the coiled spring is attached to the outside of the lure.

7. The fish grabbing device of claim 1, wherein the extension handles may be moved from the open position to the loaded position.

8. A combination fish grabbing device and lure comprising:
a coiled spring positioned inside the lure,
extension handles that extend outwardly from the coiled spring, the extension handles movable from an open position to a loaded position,
pointed ends that extend outwardly from the coiled spring,
at least one detent on one of the extension handles for holding the handles in the loaded position,
wherein when a fish explores the lure, the fish grabbing device is disturbed causing the extension handles to move from a loaded position to an open position, and simultaneously causing movement of the pointed ends from a closed position to an expanded position to grab the fish.

9. The combination of claim 8, wherein the pointed ends extend outwardly from the coiled spring in a first direction.

10. The combination of claim 9, wherein the extension handles extend outwardly from the coiled spring in a second direction.

11. The combination of claim 10, wherein the extension handles and pointed ends extend in opposite directions.

12. The combination of claim 8, wherein the coiled spring is attached inside the lure.

13. The combination of claim 8, further comprising a detent on each extension handle.

14. The combination of claim 1, wherein the extension handles may be moved from the open position to the loaded position when removing the fish grabbing device from the fish.
